(19) United States
(12) Patent Application Publication
(10) Pub. No.: US 2005/0059428 A1
(43) Pub. Date: Mar. 17, 2005

(54) Sunshade with a radio device

(76) Inventor: Benson Tung, Kaohsiung (TW)

Correspondence Address: Alan D. Kamrath;Rider Bennett, LLP, Suite 2000, 333 South Seventh Street, Minneapolis, MN, 55402, US

(21) Appl. No.: 10/663,047

(22) Filed: Sep. 15, 2003

(51) Int. Cl. H04Q 7/20

(52) U.S. Cl. 455/556.1

(57) ABSTRACT

A sunshade includes a post, a radio module mounted on the post for receiving signals from a broadcaster, and a power module mounted on the sunshade for supplying power to the radio module. In an embodiment, the power module is a solar energy device that receives solar energy and transforms solar energy into electricity. In another embodiment, the power module includes a tubular member attached to a lower end of the post and a batter-receiving member releasably mounted in the tubular member.

### BACKGROUND OF THE INVENTION

1. Field of the Invention

The present invention relates to a sunshade with a radio device.

2. Description of the Related Art

A sunshade shields people from sunlight and is thus widely used in outdoor cafes and rest areas as well as on beaches. An illuminating device is attached to a sunshade for illumination purposes, and an external power source is required. U.S. patent application Ser. No. 10/376,066 filed on Feb. 26, 2003 provides a sunshade with an illuminating device that has a solar energy receiver for receiving solar energy and providing electricity to the bulbs attached to the sunshade. The present invention is intended to provide a radio on the sunshade for increasing utility of the sunshade.

### SUMMARY OF THE INVENTION

An object of the present invention is to provide a radio on a sunshade for increasing utility of the sunshade

A sunshade in accordance with the present invention includes a post, a radio module mounted on the post for receiving signals from a broadcaster, and a power module mounted on the sunshade for supplying power to the radio module. In an embodiment, the power module is a solar energy device that receives solar energy and transforms solar energy into electricity. In another embodiment, the power module includes a tubular member attached to a lower end of the post and a batter-receiving member releasably mounted in the tubular member.

Other objects, advantages, and novel features of the invention will become more apparent from the following detailed description when taken in conjunction with the accompanying drawings.

### BRIEF DESCRIPTION OF THE DRAWINGS

FIG. 1 is a side view of a sunshade equipped with a first embodiment of a radio device in accordance with the present invention.

FIG. 2 is an exploded perspective view of a radio module of the radio device in FIG. 1.

FIG. 3 is a sectional view taken along line 3-3 in FIG. 1.

FIG. 4 is an exploded perspective view of a power module of the radio device.

FIG. 5 is an exploded perspective view illustrating a modified embodiment of the power module of the radio device.

FIG. 6 is a sectional view of an upper portion of a sunshade equipped with the power module in FIG. 5.

FIG. 7 is a sectional view similar to FIG. 6, wherein the sunshade is in an unfolded state.

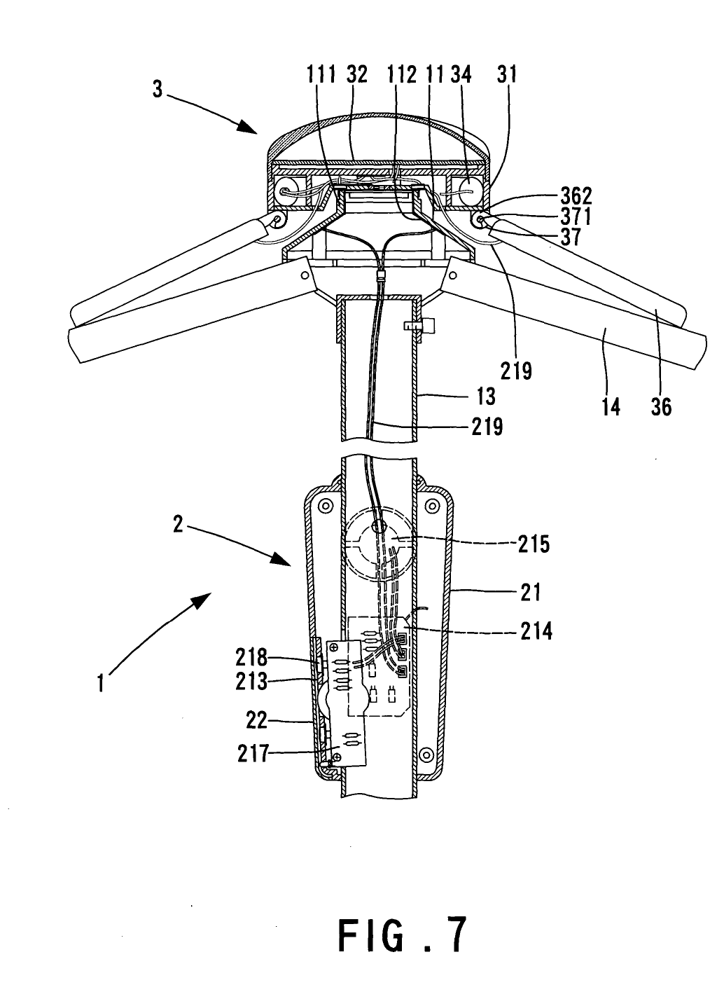

FIG. 8 is a side view of a sunshade equipped with another embodiment of the radio device in accordance with the present invention.

FIG. 9 is an exploded perspective view of a lower portion of the sunshade in FIG. 8.

FIG. 10 is a sectional view taken along line 10-10 in FIG. 8.

### DETAILED DESCRIPTION OF THE PREFERRED EMBODIMENTS

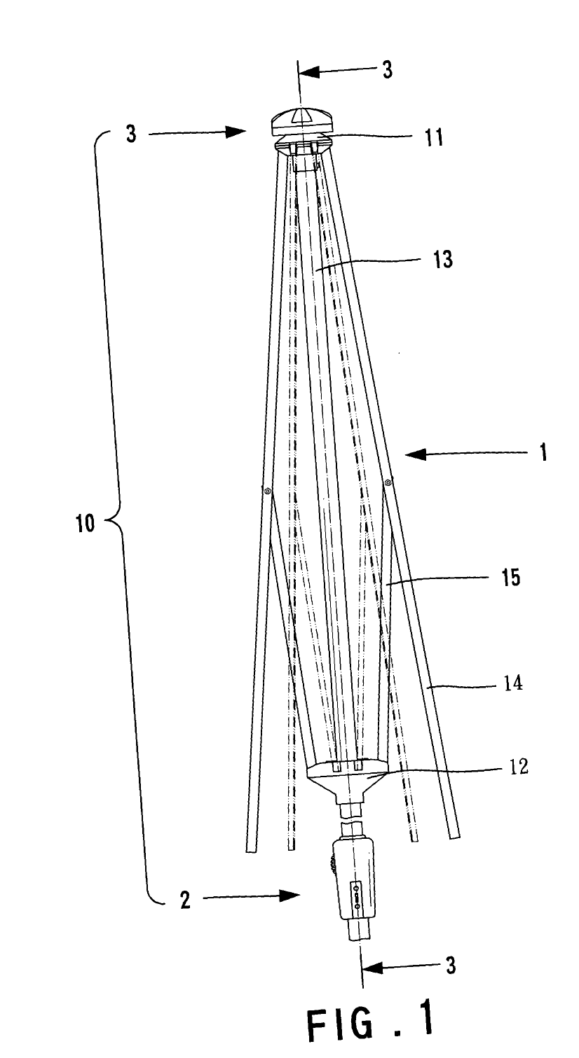

Referring to FIG. 1, a radio device 10 in accordance with the present invention is attached to a sunshade 1 that generally comprises a post 13, a rib-mounting member 11 on top of the post 13, a plurality of ribs 14 each having an end pivotally connected to the rib-mounting member 11, a runner 12 slidably mounted to the post 13, a plurality of stretchers 15 each having a first end pivotally connected to the runner 12 and a second end pivotally connected to an intermediate portion of an associated one of the ribs 14.

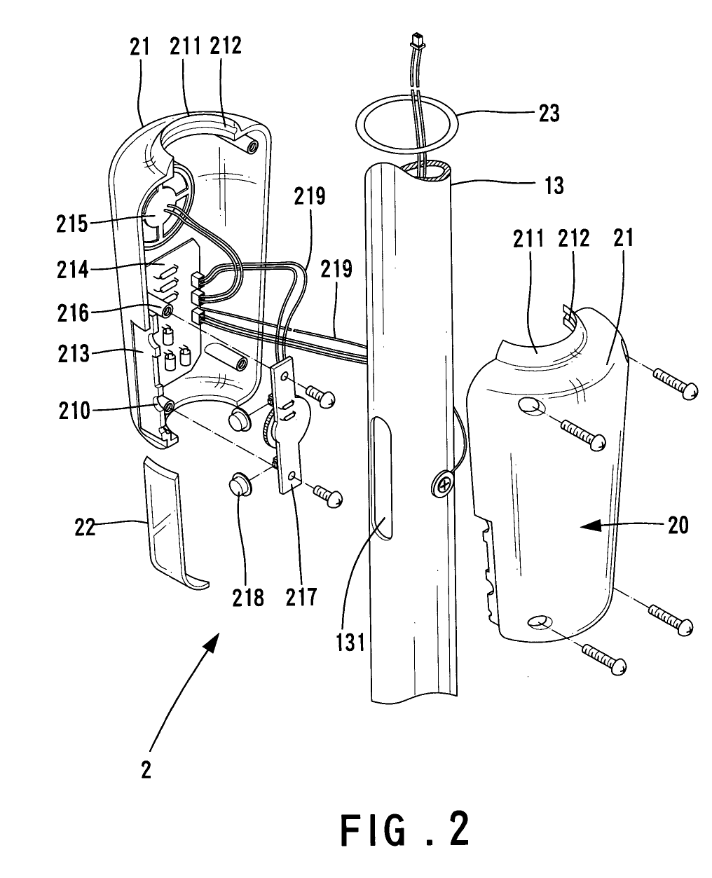

Still referring to FIG. 1 and further to FIGS. 2 through 4, the radio device 10 in accordance with the present invention is mounted on the sunshade 1 and includes a radio module 2 for receiving signals from a broadcaster (not shown) and a power module 3 for supplying power to the radio module 2. In this embodiment, the radio module 2 is mounted on the post 13 at a position below the runner 12 without interfering with operation of the runner 12. The radio module 2 includes a casing 20 consisting of two casing halves 21 that are coupled with each other and securely mounted around the post 13. Each casing half 21 includes a groove 212 (preferably semi-circular) in an upper end 211 thereof, with a gasket 23 being received in the grooves 21 to provide a sealing effect. Thus, water is prevented from entering the radio module 2 via an outer periphery of the post 13.

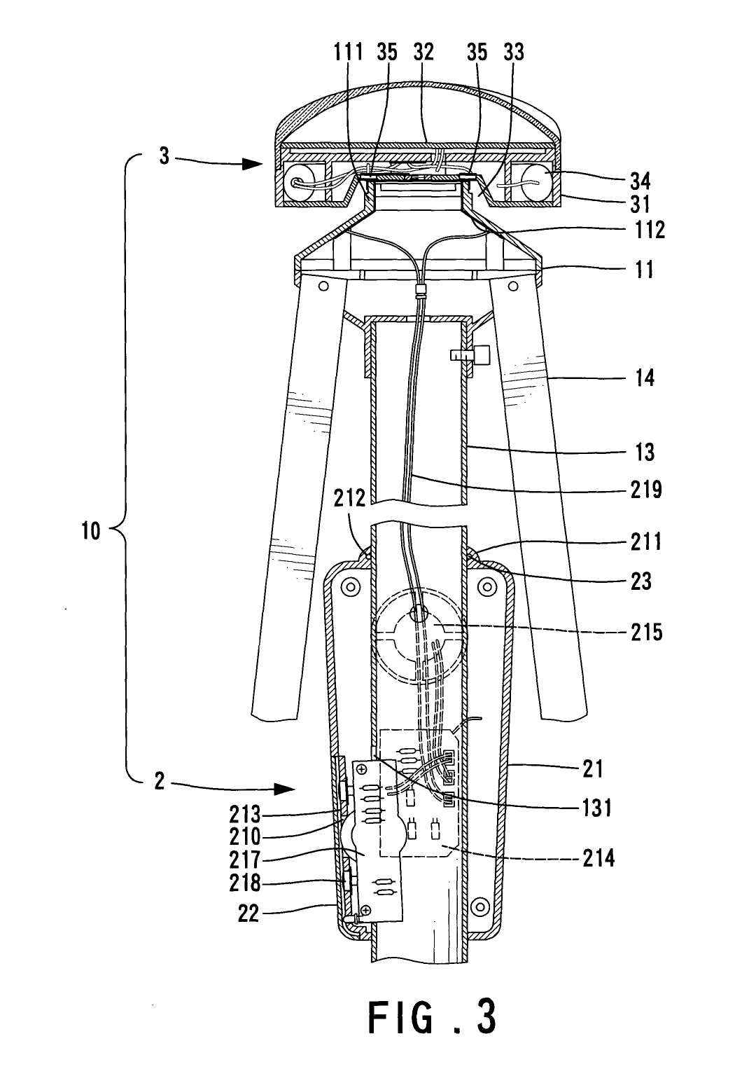

The casing 20 further includes a recessed control panel section 213. A lid 22 is mounted to the casing 20 and slidable between a closed position in which the recessed control panel section 213 is hidden by the lid 22 and an open position in which the recessed control panel section 213 is exposed for manual operation. A circuit board 214 and a loud speaker 215 are mounted in one of the casing halves 21. Further, this casing half 21 includes two pegs 216 each having a screw hole (not labeled). A control plate 217 is secured to the pegs 216 by fasteners and includes a plurality of control elements such as buttons and/or knobs 218 that extend beyond the recessed control panel section 213 via holes 210 in the recessed control panel section 213. The post 13 includes a slot 131 into which the control plate 217 extends, best shown in FIG. 3. The loud speaker 215 and the control plate 217 are electrically connected by wires 219 to the circuit board 214. The circuit board 214 is electrically connected by wires 219 to the post 13 so that the post 13 may act as an antenna for receiving signals from a broadcaster. The buttons and/or knobs 218 allow the user to control on/off, tuning in, volume adjustment, etc. of the radio module 2.

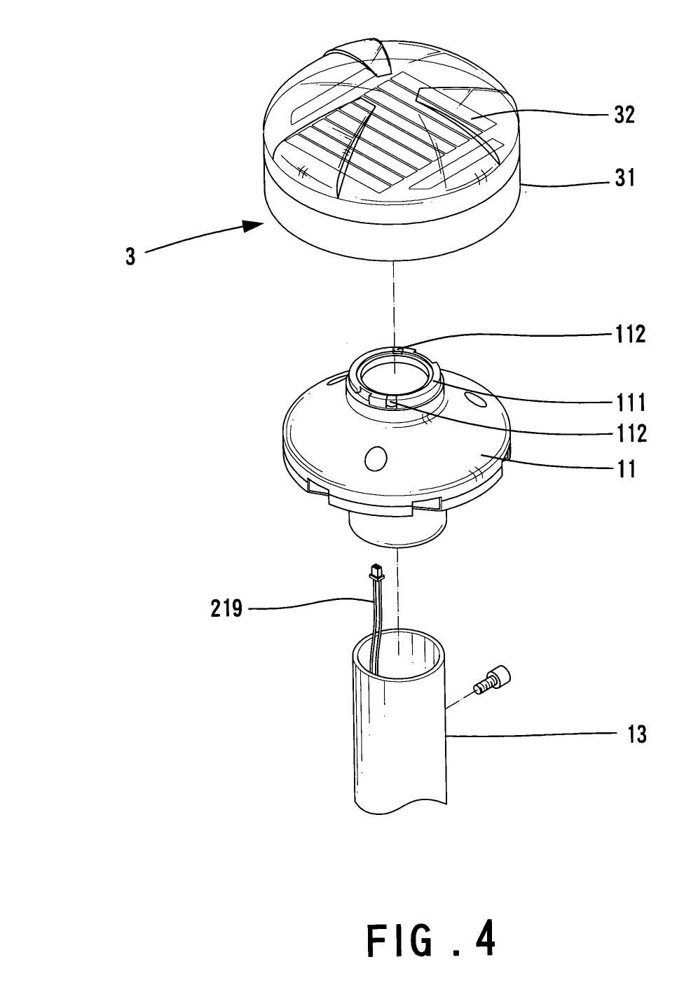

Referring to FIGS. 3 and 4, the power module 3 is mounted on the rib-mounting member 11. In this embodiment, the rib-mounting member 11 includes two conductive plates 112 that are electrically connected by wires 219 to the circuit board 214. The power module 3 is preferably a solar energy device mounted to the rib-mounting member 11. In this embodiment, the power module 3 includes a housing 31 for receiving a photoelectric plate 32 and at least one solar battery 33 that are electrically connected by wires 219 to the photoelectric plate 32. Thus, the solar battery 34 stores energy that is obtained at the photoelectric plate 32 that transforms solar energy into electricity. The housing 31 includes a recessed portion 33 in an underside thereof for securely engaging with the rib-mounting member 111, and two conductive plates 35 are provided on the recessed portion 33 and respectively connected to the positive pole and the negative pole of the solar battery 34. Further, the conductive plates 35 are in contact with the conductive plates 112 of the rib-mounting member 111, thereby supplying power from the power module 3 to the radio module 2. Thus, the user may use the radio device 10 for a long period of time without the need of frequently replacing the solar battery 34.

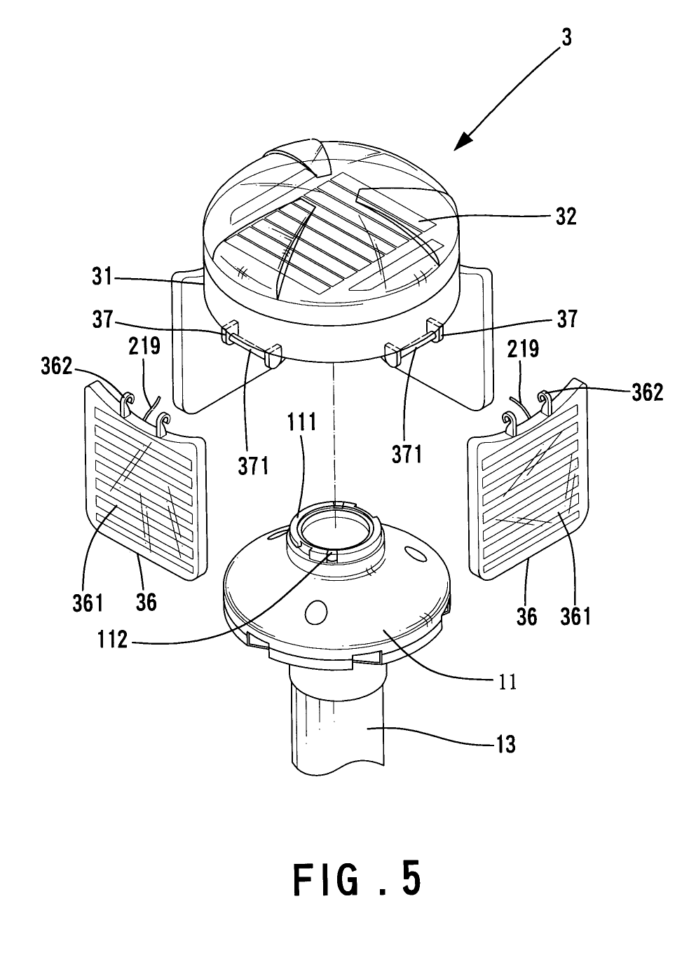

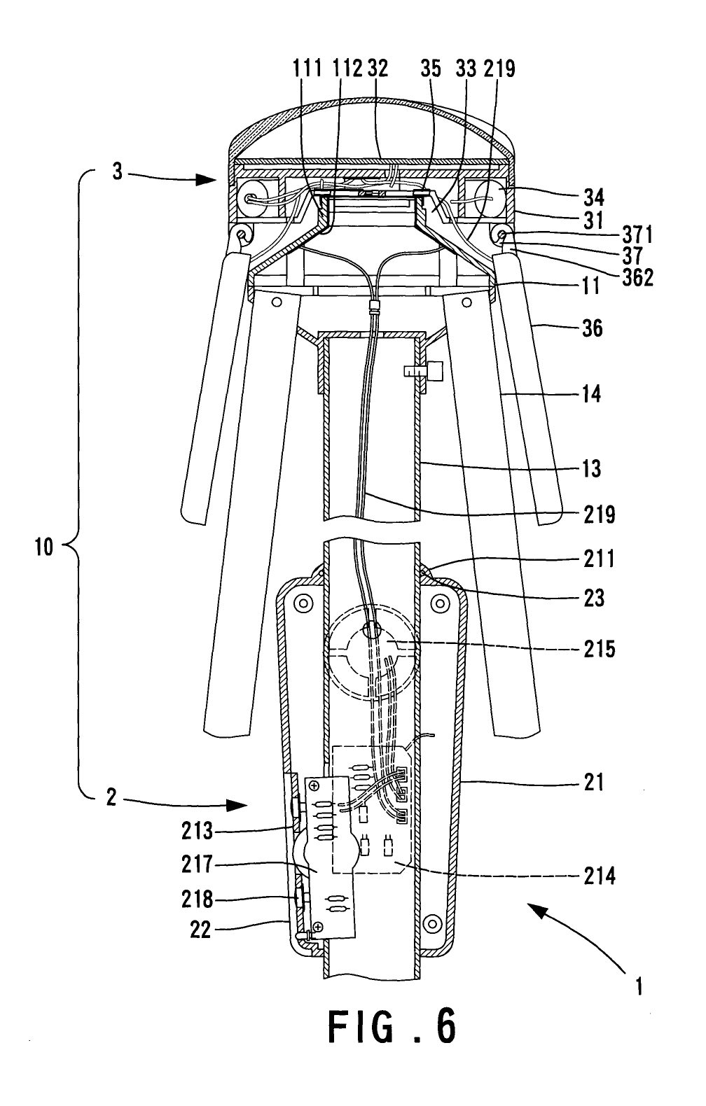

FIG. 5 illustrates a modified embodiment of the power source of the radio device. In this embodiment, the housing 31 further includes two mounting portions 37 each having a pivot 371, and two solar energy-collecting members 36 are pivotally mounted to the mounting portions 37. Each solar energy-collecting member 36 includes two pivotal hooked members 362 pivotally connected to the respective pivot 371 and a photoelectric plate 361 electrically connected by a wire 219 to the solar battery 34 of the housing 31. The sunshade in FIG. 6 is in a folded state, and the solar energy-collecting members 36 are in their inoperative position. When the sunshade is unfolded, the solar energy-collecting members 36 are moved to their operative position by the ribs 14 via transmission by a canopy (not shown) mounted to the ribs 14. When the sunshade is folded, the solar-energy-collecting members 36 fall to the canopy under the action of gravity.

The power module 3 may be mounted on the sunshade at a place other than the rib-mounting member 11. For example, the power module 3 may be mounted on the upper side of the canopy of the sunshade for receiving solar energy and transforming it into electricity that is then stored in the solar battery 34.

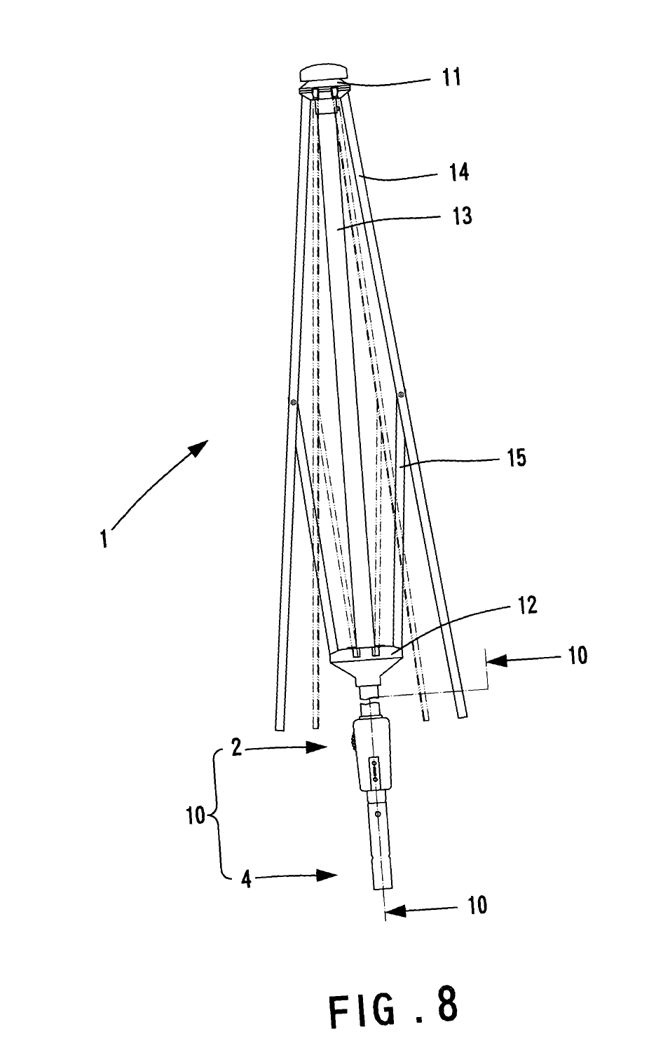

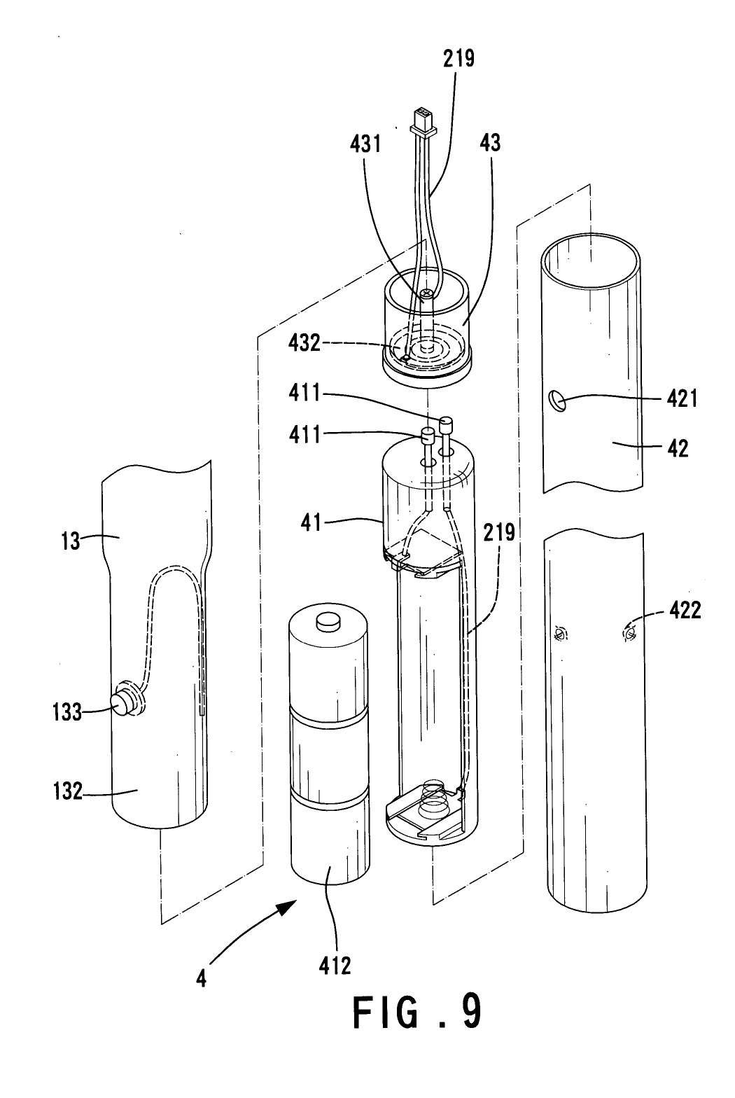

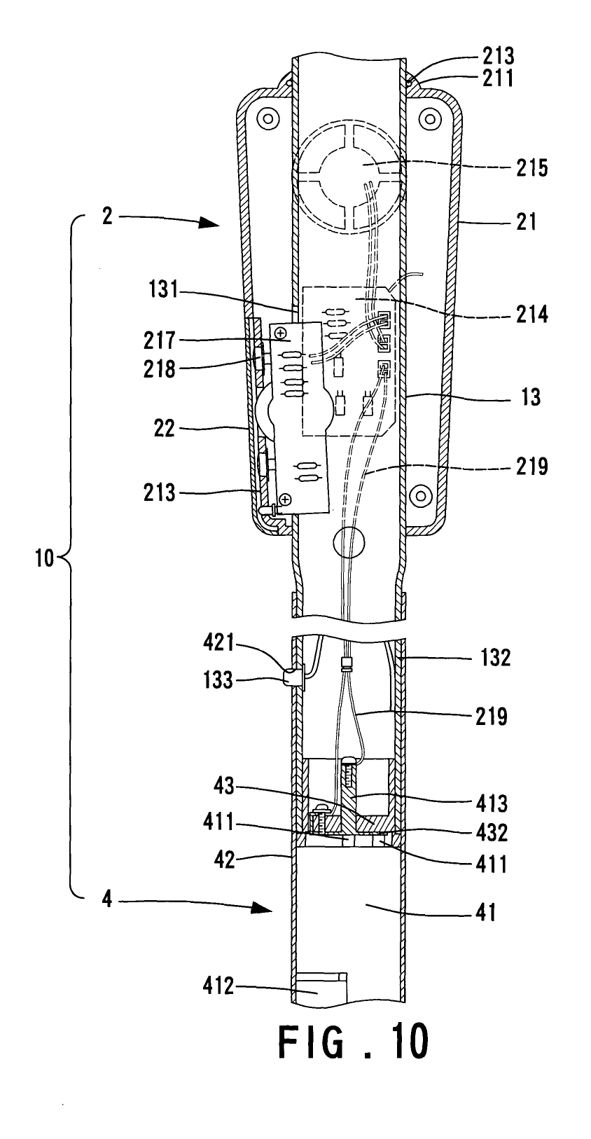

FIGS. 8 through 10 illustrate another modified embodiment of the power module (now designated by 4). In this embodiment, the post 13 includes a reduced lower end 132 on which a spring-biased positioning button 133 is mounted. The power module 4 includes a tubular member 42 having a transverse positioning hole 421, a battery-receiving member 41 mounted in the tubular member 42, and a connecting member 43. The connecting member 43 includes a conductive member 431 provided in a central portion thereof for electrical connection with the circuit board 214 by wires 219. An annular conductive member 432 is provided on the connecting member 43 and spaced from the conductive member 431. The annular conductive member 43 is also electrically connected to the circuit board 214 by wires 219. The spring-biased positioning button 133 extends through the transverse positioning hole 421 of the tubular member 42, which will be described later. The tubular member 42 has two protrusions 422 on an inner periphery of a lower end thereof. The protrusions 422 are formed by means of punching the tubular member 42.

The battery-receiving member 41 includes a compartment for receiving a battery unit 412 having a positive pole and a negative pole that are respectively and electrically connected by wires 219 to two conductive pins 411, which, in turn, are respectively in contact with the conductive member 431 and the annular conductive member 432. Thus, the power module 4 provides power to the radio module 2. A lower end of the battery-receiving member 41 rests on the protrusions 422 of the tubular member 42. When replacement of the battery unit 412 is required, the spring-biased positioning button 133 is pressed and disengaged from the transverse positioning hole 421 of the tubular member 42, allowing the tubular member 42 to be disengaged from the post 13. Next, the battery-receiving member 41 is removed for subsequent replacement of the battery unit 412.

Although the invention has been explained in relation to its preferred embodiment, it is to be understood that many other possible modifications and variations can be made without departing from the scope of the invention as hereinafter claimed.

1. A sunshade comprising:
a post;
a radio module mounted on the post, the radio module being adapted to receive signals from a broadcaster; and
a power module mounted on the sunshade for supplying power to the radio module.

2. The sunshade as claimed in claim 1, further including:
a rib-mounting member mounted on the post;
a plurality of ribs each having an upper end pivotally connected to the rib-mounting member;
a runner slidably mounted on the post; and
a plurality of stretchers each having an upper end pivotally connected to an intermediate portion of an associated one of the ribs and a lower end pivotally connected to the runner.

3. The sunshade as claimed in claim 1, wherein the power module is a solar energy device that receives solar energy and transforms solar energy into electricity.

4. The sunshade as claimed in claim 3, wherein the solar energy device includes a photoelectric plate and at least one solar battery electrically connected to the photoelectric plate.

5. The sunshade as claimed in claim 2, wherein the power module is a solar energy device that receives solar energy and transforms solar energy into electricity.

6. The sunshade as claimed in claim 5, wherein the solar energy device includes a housing, with a photoelectric plate and at least one solar battery being received in the housing, with at least one solar battery being electrically connected to the photoelectric plate.

7. The sunshade as claimed in claim 6, further including at least one solar energy collecting member pivotally mounted to the housing, said at least one solar energy collecting member including at least one photoelectric plate electrically connected to said at least one solar battery, said at least one solar energy collecting member being pivoted when the ribs move from a folded state to an unfolded state.

8. The sunshade as claimed in claim 1, wherein the power module includes a tubular member releasably connected to a lower end of the post, the power module further including a battery-receiving member releasably received in the tubular member and a battery unit received in the battery-receiving member.

9. The sunshade as claimed in claim 1, wherein the radio module includes a casing consisting of two casing halves securely connected together and mounted around the post, the casing including a circuit board and a loud speaker mounted therein, the loud speaker being electrically connected to the circuit board, the casing further including a control panel section and a control plate mounted to the control panel section, a plurality of control elements being mounted on the control panel and extending beyond the control panel section for manual operation.

10. The sunshade as claimed in claim 9, wherein the control panel section is a recessed section of the casing, further including a lid mounted to the casing and slidable between a first position in which the control panel section is hidden by the lid and a second position in which the control panel section is exposed for manual operation.

11. The sunshade as claimed in claim 10, wherein the post includes a slot into which the control panel extends.

12. The sunshade as claimed in claim 10, wherein each said casing half includes a groove in an upper end thereof, further including a gasket mounted in the grooves of the casing halves for preventing water from entering the casing.

13. The sunshade as claimed in claim 9, wherein the circuit board further includes a wire electrically connected to the post, thereby forming an antenna for receiving the signals from the broadcaster.

14. The sunshade as claimed in claim 9, wherein the power module is a solar energy device that receives solar energy and transforms solar energy into electricity.

15. The sunshade as claimed in claim 14, wherein the solar energy device includes a housing, with a photoelectric plate and at least one solar battery being received in the housing, with at least one solar battery being electrically connected to the photoelectric plate.

16. The sunshade as claimed in claim 15, further including at least one solar energy collecting member pivotally mounted to the housing, said at least one solar energy collecting member including at least one photoelectric plate electrically connected to said at least one solar battery, said at least one solar energy collecting member being pivoted when the ribs move from a folded state to an unfolded state.

17. The sunshade as claimed in claim 16, wherein said at least one solar battery is electrically connected to the circuit board and thus supplies power to the circuit board.

18. The sunshade as claimed in claim 9, wherein the power module includes a tubular member releasably connected to a lower end of the post, the power module further including a battery-receiving member releasably received in the tubular member and a battery unit received in the battery-receiving member.

19. The sunshade as claimed in claim 18, wherein the battery unit includes a positive pole and a negative pole that are electrically connected to the circuit board.

20. The sunshade as claimed in claim 19, wherein the battery unit includes a positive pole and a negative pole that are respectively and electrically connected to two conductive pins, further including a connecting member mounted in the tubular member and having a conductive member in a central portion thereof and an annular conductive member that is spaced from the conductive member, the conductive pins being respectively, electrically connected to the conductive member and the annular conductive member of the connecting member, the conductive member and the annular conductive member being electrically connected to the circuit board.
